(19) United States
(12) Patent Application Publication
(10) Pub. No.: US 2016/0047500 A1
(43) Pub. Date: Feb. 18, 2016

(54) COUPLING AND USE

(71) Applicant: NGI A/S, Nørresundby (DK)

(72) Inventor: Tomas Hecht OLSEN, Nørresundby (DK)

(21) Appl. No.: 14/778,991

(22) PCT Filed: Mar. 17, 2014
(86) PCT No.: PCT/DK2014/000014

§ 371 Date: Sep. 21, 2015

(30) Foreign Application Priority Data
Mar. 22, 2013 (DK) PA 2013 00164
Nov. 19, 2013 (DK) PA 2013 00653

(51) Int. Cl. F16L 25/14; F16L 21/00

(52) U.S. Cl. CPC F16L 25/14; F16L 21/002

(57) ABSTRACT

The invention relates to a coupling (1) for placement in a hole, where the coupling (1) is pipe shaped, includes at least a base part (2) and at least a first sealing part (3), which is suited for sealing against the insert (5) and at least another sealing part (4). The coupling includes at least one outgrowth (14) on the exterior side of the coupling (1), where the coupling (1) includes an exterior surface (1′) and an internal surface (1″). The first sealing part (3) is mounted with contact against the inner surface (1″) and is designed to seal against the insert (5) and the second sealing part (4) is mounted with contact against the outer surface (1′) and designed to seal against the hole part. The invention also relates to the use of the coupling (1) for connections where there is to be controlled and/or sealed in a hole.

### CROSS-REFERENCE TO RELATED APPLICATIONS

This application is a U.S. national state of International Appl. No. PCT/DK2014/000014 filed 17 Mar. 2014, which claimed priority to Danish Appl. Nos. PA 2013 00164 filed 22 Mar. 2013 and PA 2013 00653 filed 19 Nov. 2013, which applications are incorporated herein by reference in their entireties.

### TECHNICAL FIELD

The invention relates to a coupling for placement in a hole such as a hole in a machine part or in a pipe and around an insert such as a pipe or an axle, where the said coupling is pipe shaped and includes at least one base part and at least one first sealing part and at least another sealing part and furthermore at least one outgrowth on the exterior side of the coupling where the said coupling includes an exterior surface and an interior surface and that the first sealing part is mounted with contact against the inner surface and made to seal against the insert, and where the said second sealing part is mounted with contact against the exterior surface and designed to seal against the hollow part including a pipe. The invention also relates to the use of the coupling.

### BACKGROUND

For assembly in adjustable connections, including legs for tables with special demands for being cleaning-friendly, several components are often used, which each fill a function.

A simple coupling, a bush or a friction bearing is often used to control an insert including a pipe or an axle in relation to a part with a hole including a pipe.

For this purpose, several products from various materials can be used suited for gliding but without sealing and conducting features.

A sealing part is therefore also often used, such as an O-ring to seal between the hollow part and the insert. This sealing part will also be able to function as scraper ring and thereby scrape filth from the insert when the insert is moved in relation to the hollow part.

Also, a separate conducting connection is used when needed, such as a wire and collector shoe to form electrical contact between hollow part and insert.

There are several drawbacks of the known technology, including that it does not comply with 3A and EHEDG requirements for cleaning-friendly design and that it requires more components such as coupling, bush or friction bearing combined with a scraper ring and/or sealing ring and a wire and collector shoe for creating electrical contact.

From WO 9819093 is known a coupling for connecting a pipe and a fitting. The coupling includes a cylindrical casing provided with two sealing rings placed in each end of the casing. Each sealing ring is penetrated by the casing such that by placing the coupling between pipe and fitting, each sealing ring will have contact against both the internal side of the pipe and the exterior of the relevant fitting. The construction is relatively complicated and requires that the two sealing rings belonging to a coupling are placed identically in relation to the coupling such that the distance between each sealing ring's highest point and the surface of the coupling is the same in order to secure a connection with a minimum of slack. Also, the connection between the sealing rings and the coupling itself is inappropriate seen from a hygienic point of view since the transition between them forms breeding ground for bacterial growth. The coupling will thus not be able to meet the requirements, which are specified in EHEDG Guidelines (Hygienic design for open equipment for processing of food).

DE 2014329 discloses a coupling as stated in the introduction. The coupling does not comprise tracks for placing sealing rings and does not exclude that bacterium is entering the interior of the connection. For that, the construction is inappropriate seen from a hygienic point of view. Further, the coupling does not meet the requirement specified in EHEDG Guidelines.

### SUMMARY OF THE INVENTION

An aspect of the present invention is to create a coupling, which does not have the above mentioned drawbacks, or which at least provides a useful alternative. A further aspect is to improve the known technique for assembly of an insert, including a pipe or and axle and a hollow part including a pipe.

This object is achieved by a coupling of the in the introduction stated type and where the outer surface includes an outer track and the inner surface includes an inner track where the said first sealing part is mounted in the inner track and designed to seal towards the insert and where the second said sealing part is mounted in the outer track and designed to seal against the hollow part including a pipe.

The inner surface is thus the surface which turns towards the insert and the exterior surface is the surface, which faces towards the pipe. In this way it thus becomes possible that a single item in chosen materials functions as friction bearing, sealing and conducting connection and which also complies with 3A and EHEDG requirements for being cleaning-friendly.

The integrated item has also got the advantage that the sealing parts do not fall out and that bacteria can thereby not grow between the sealing parts and the base part and that the risk of slack in the connection is minimised. The coupling's sealing parts are also available for visual inspection. Further appropriate embodiments of the coupling are shown and described further below.

From an additional aspect of the invention, the outgrowth includes an outer surface in which the outer track is fully or partially placed and the second sealing part is mounted in the outer track and designed to seal against the hollow part including a pipe and that the one end surface of the coupling includes the inner track in which the first sealing part is mounted and designed to seal towards the insert.

By an additional aspect of the invention, the coupling includes that the base part includes items that are designed to create a mechanical locking between the coupling and the hollow part including by mesh with an embossing in the pipe, where these items include an embossing in the coupling, quite congruent with the embossing in the pipe and a free surface, projecting from the outgrowth, whose surface consist a part of the outer track.

By an additional aspect of the invention, the coupling part consists of a material, which is electrically conducting, preferably an electrical conducting polymer and where the said coupling is designed to have physical contact to both the insert and the hollow part including the pipe. The coupling can, however, be composed by several types of materials for example steel and polymer or only steel or only polymer.

By an additional aspect of the invention, the contact between the coupling and the insert includes contact zones, including a lip contact and the contact between the coupling and the hollow part includes another contact zone including a pressure contact.

By an additional aspect of the invention, the lip contact is established by the coupling's one end and opposite the end where the outgrowth is placed.

By an additional aspect of the invention, the coupling includes that the pressure contact includes an embossing in the hollow part, where this embossing is designed to go in mesh with a mostly identical embossing on the base part's outer surface.

By an additional aspect of the invention, the coupling includes that the base part is shaped such that a mechanical locking is created between the coupling and the hollow part including by mesh with an embossing in the pipe and with an outgrowth.

By an additional aspect of the invention, the coupling includes that the first sealing part and the second sealing part consist of an elastic material such as a polymer, for example an elastomer, which creates a sealing between the base part to the insert and the hollow part including the pipe whereby 3A and EHEDG requirements for cleaning-friendliness are complied with.

By an additional aspect of the invention, the coupling includes that the elastic material has a hardness of 45-70 shoreA preferably 50-65 shoreA.

By an additional aspect of the invention, the coupling includes that the first sealing part and the second sealing part are placed at the same end of the base part.

By an additional aspect of the invention, the coupling is manufactured by injection moulding including a two component injection moulding.

By an additional aspect of the invention, the coupling includes that the base part and the first and second sealing parts are connected to each other by a chemical and/or thermal fusion.

By an additional aspect of the invention, the coupling is designed to be placed in round or polygonal holes and around round or polygonal inserts.

By an additional aspect of the invention, the coupling is manufactured from one or more materials including metallic, polymeric, mineral and/or biological materials.

As mentioned, the invention also relates to the use of the coupling according to the above characteristics for connections where there is to be guided and/or sealed in a hole, including a pipe and an insert such as a pipe or an axle where the insert is designed to be moved in relation to the coupling whereby filth on the insert is exposed and makes it possible to scrape it off and/or there is established a conducting connection between the insert and the hollow part including a pipe where this connection counteracts static electricity.

It hereby becomes possible to connect hollow part and insert with only one item, which functions as friction bearing, sealing and conducting connection.

The invention also relates to use of the coupling for connections where the connection must comply with 3A and EHEDG requirements for cleaning-friendliness. It hereby becomes possible to connect hollow part and insert with only one item, which complies with 3A and EHEDG requirements for cleaning-friendliness.

### BRIEF DESCRIPTION OF THE DRAWINGS

The invention will now be explained more fully with reference to the drawings, in which:

FIG. 1 shows a 3D picture of the coupling and its three parts.

FIG. 2 shows a detailed view, which is shown on FIG. 6 through coupling, an insert and a pipe in which the coupling is fully mounted.

FIG. 3 shows the coupling seen from the side.

FIG. 4 shows a view through the coupling, as indicated on FIG. 3.

FIG. 5 shows a magnification as indicated on FIG. 4 of the detail around the two sealing parts.

FIG. 6 shows an example of adjustable legs with couplings mounted.

FIG. 7 shows a 3D diagram of adjustable legs with couplings mounted.

### DETAILED DESCRIPTION OF THE INVENTION

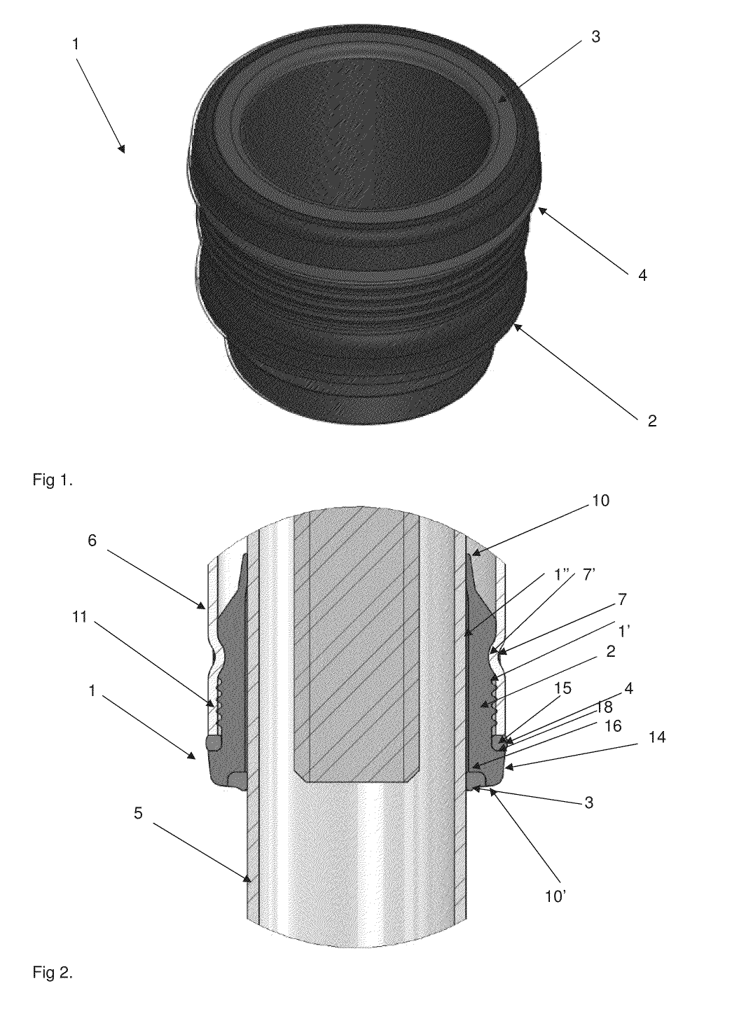

On FIG. 1 is with (1) shown a coupling, which consists of a base part (2), a first sealing part (3) and another sealing part (4). The three parts are coherent and together they form a single item. The sealing part (3) and the sealing part (4) are placed in the same end of the base part (2) on the coupling (1).

The two sealing parts (3), (4) can also be placed differently in relation to the base part (2) and have other shapes.

The coupling (1) can be manufactured from injection moulding including two-component injection moulding.

The base part (2) can be manufactured from a polymeric material including a conducting polymeric such as a polypropylene of the type Premix PP1376 with 11% Sabic PP512MN50 or a high density polyethylene of the type PRE-ELEC® PE 1296.

The sealing parts can be manufactured from a polymeric material including a softer thermoplastic elastomer such as Chemiton TPE HPB1DA56.001 mixed with 2.7% Blue Master Batch 1A600036M.

The choice of the two materials will by use of two component injection moulding ensure a chemical and thermal binding between the materials in order to give the connection a similar or greater strength than the surrounding material. This binding ensures that the sealing parts (3), (4) do not fall out and that bacteria can thereby not occur between the sealing parts (3), (4) and the base part (2).

In FIG. 2 is with (1) shown a coupling consisting of a base part (2), a first sealing part (3) and another sealing part (4), mounted between a pipe (6) and an insert (5).

The first sealing part (3) forms sealing between the base parts (2) and the insert (5) and the second sealing part (4) forms sealing between the base part (2) and the pipe (6).

The transition between the second sealing part (4) and pipe (6) and transition between first sealing part (3) and insert (5) comply with 3A and EHEDG requirements for cleaning-friendliness.

In FIG. 2 is with (10) shown a springy lip contact zone between base part (2) and insert (5), which ensures an electric connection between these two items and a well-defined slide. The shape of the base part (2) in this area ensures that there is always contact to the insert (5).

Also, there is with (11) shown a pressure contact zone between base part (2) and pipe (6), which ensures an electronic connection between these two items and a mechanical placement of the coupling (1) in relation to the pipe (6). There is no movement between the base part (2) in the coupling (1) in relation to the pipe (6) during use, so this connection is therefore only a pressure zone.

In FIG. 2 is with (7) also shown an embossing in pipe (6), which creates a mechanical positioning and locking between the coupling (1) and the pipe (6). The shape of the embossing (7) on the pipe (6) does not increase the requirements for cleaning. The embossing's (7) mesh with, and locking, of the base part (2) in the coupling (1) ensures an optimum pressure on the sealing part (4) between pipe (6) and the outgrowth (14), which is a part of the base part (2). The embossing (7) is designed to go in mesh with a highly similar embossing (7) on the base part's (2) outer surface. This technique supports that the connection between the sealing part (4) on the coupling (1) and the pipe (6) comply with 3A and EHEDG requirements for cleaning-friendliness.

The mechanical positioning and locking of the coupling (1) can also be carried out with other methods.

In FIG. 2 is with (14) also shown an outgrowth on the base part (2), which forms support for the second sealing part (4) against the pipe's (6) end surface. This ensures, together with the mechanical locking in the embossing (7), that there is a well-defined sealing pressure on the second sealing part (4) between pipe (6) and the outgrowth (14), which is a part of the base part (2).

This outgrowth (14) also prevents that the coupling (1) can be pressed too far into the pipe (3) during assembly and/or during use.

The coupling (1) includes an outer surface (1′) and an inner surface (1″) and the first sealing part (3) is mounted with contact against the inner surface (1″) and designed to seal against the insert (5). The second sealing part (4) is mounted with contact towards the outer surface (1′) and designed to seal against the hollow part including a pipe (6).

The outer surface (1′) also includes an outer track (15) and the inner surface (1″) includes an inner track (16). The sealing part (3) is mounted in the inner track (16) and the second sealing part (4) is mounted in the outer track (15). The outgrowth (14) includes an outer surface in which the outer track (15) is fully or partially placed. The coupling's (1) one end surface (10′) in connection with the inner surface (1″) include the inner track (16) in which the first sealing part (3) is mounted. By track should be understood a well-defined geometry in which the preferably ring shaped sealing part abuts on with a part of its surface in a stable way.

The base part (2) includes items, which are designed to create a mechanical locking between the coupling (1) and the hollow part, including by mesh with an embossing (7) in the pipe (6), which items include an embossing (7′) in the coupling. This embossing is mostly congruent with the embossing in the pipe (6). The mechanical locking also includes a projecting surface (18) on the outgrowth (14), which is mostly radial. This surface (18) consists a part of the outer track (15). The surface can form an angle of 45-140 degrees with the coupling's longitudinal axis.

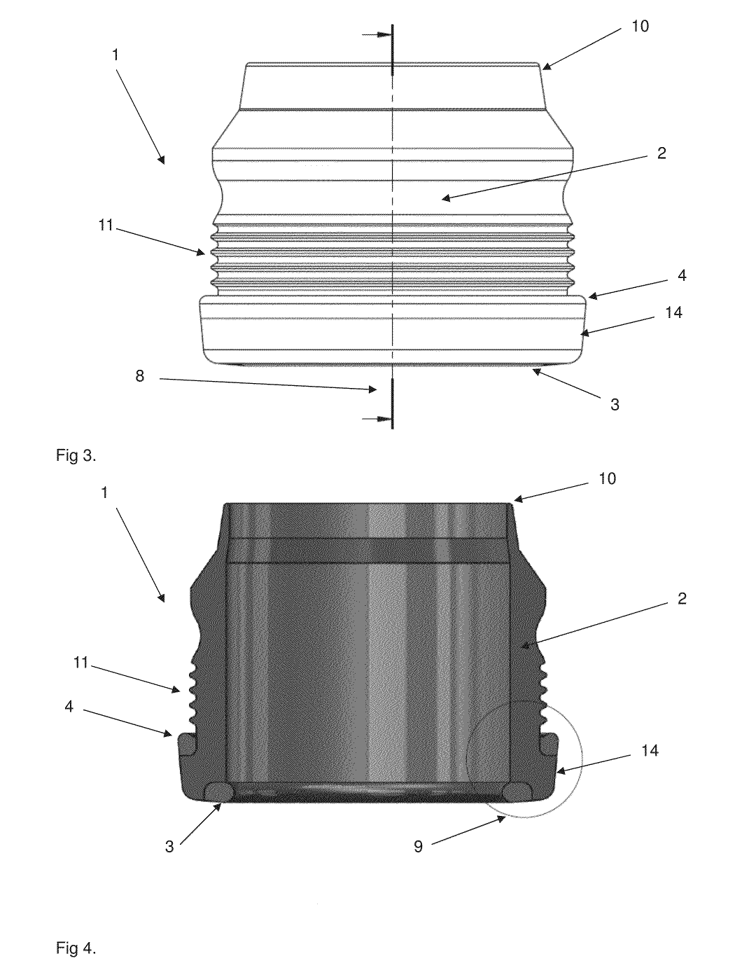

In FIG. 3 is with (1) shown a coupling consisting of a base part (2), a first sealing part (3) and a second sealing part (4). The coupling (1) is here shown from the side and shows that the three parts consist a coherent unit. In FIG. 3 is with (8) shown a sectional view where the cut through the coupling (1) is shown in FIG. 4.

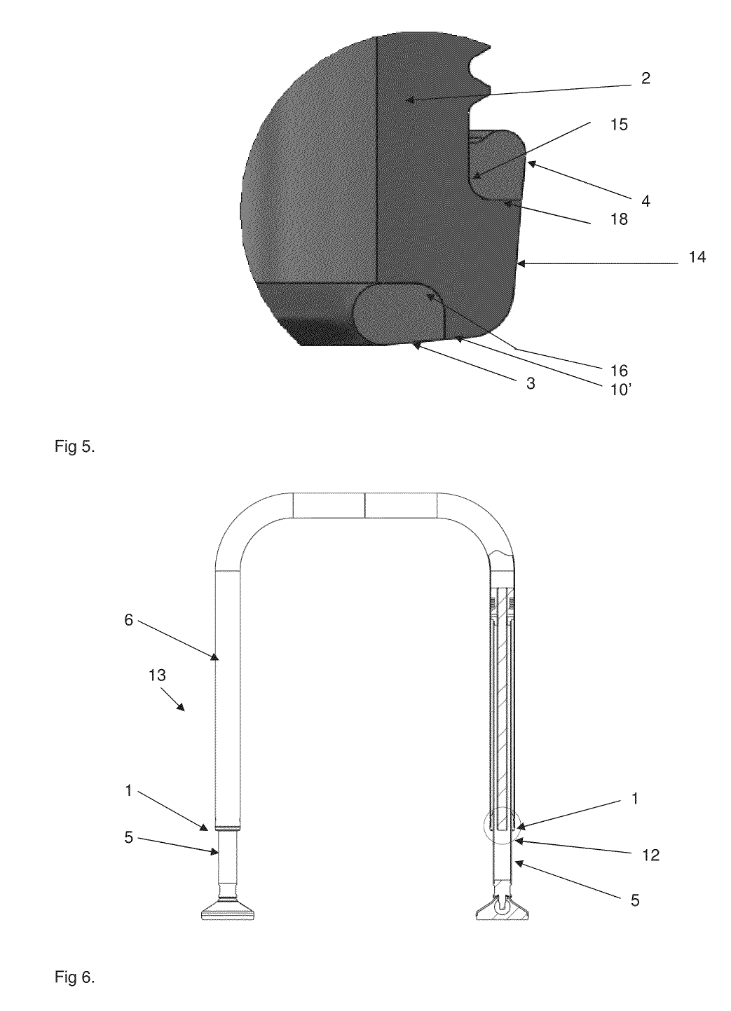

In FIG. 4 is with (1) shown a coupling consisting of a base part (2), a first sealing part (3) and another sealing part (4). The coupling (1) is here shown in a section and the parts are shown with different shadings. In FIG. 4 is with (9) shown a detail, which is magnified in FIG. 5.

In both FIG. 3 and FIG. 4 is with (10) shown where the lip contact zone is placed on the base part (2). With (11) is shown where the pressure contact zone is placed on the base part (2) and with (14) is shown where the outgrowth is placed on the base part (2). The coupling's lip contact zone is placed in opposite end of the coupling (1) in relation to where the outgrowth (14) is placed.

In FIG. 5 is shown a magnification of the detail highlighted in FIG. 4, consisting of a base part (2), a first sealing part (3) and another sealing part (4). The three parts are connected.

In FIG. 6 is with (13) shown adjustable legs consisting of a contiguous pipe (6), which is bent and forms two legs. In each of the two legs is mounted a coupling (1) and an insert (5). The drawing is shown partially as a section such that it is possible to look into one of the legs. In FIG. 6 is with (12) shown a detail marking, which is shown magnified in FIG. 2 as a shaded drawing.

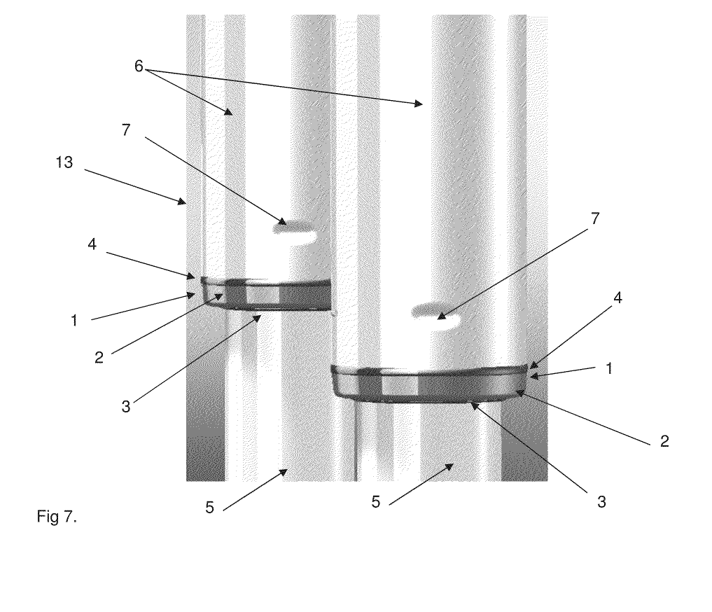

In FIG. 7 is with (13) shown a part of two adjustable legs consisting of a coherent pipe (6), which is bent and forms two legs. In each of the two legs is mounted a coupling (1) and an insert (5) where each coupling (1) consists of a base part (2), a first sealing part (3) and another sealing part (4).

In FIG. 7 is with (7) shown an embossing in the pipe (6), which functions as mechanical positioning and locking of the coupling (1).

The coupling (1) can also be mounted in individual legs and/or in other connections between an insert (5) and a hollow part, including a machine part or a pipe (6). Base part (2), the first sealing part (3) and second sealing part (4), which consist the coupling (1) can have other shapes than the shown example in FIG. 1-7.

From the above it is stated that the coupling (1) is pipe shaped and can consist of at least a base part (2) and at least one first sealing part (3), which is suited for sealing against the insert (5) and at least another sealing part (4), which is suited for sealing against the hollow part including the pipe (6) and furthermore at least one outgrowth (14) on the exterior side of the coupling.

The coupling (1) can besides the above examples with round pipes and inserts also be adapted to and used for placement between other cross sectional shapes including polygonal holes and inserts.

In a preferred embodiment, the base part (2) and the sealing parts (3), (4) in the coupling (1) are manufactured from polymeric materials cast together by a two-component injection moulding. The base part (2) in a black material and the sealing parts (3), (4) in a blue material.

1.-17. (canceled)

18. A coupling for placement in a hole, such as a hole in a machine part or in a pipe, and around an insert such as a pipe or an axle, where the said coupling is pipe shaped and comprises:
an exterior surface and an interior surface;
at least one base part;
at least one first sealing part mounted with contact against the inner surface and configured to seal against the insert;
at least one second sealing part mounted with contact against the exterior surface and configured to seal against the hollow part including the pipe; and
at least one outgrowth on the exterior surface of the coupling;
wherein the exterior surface includes an outer track and the interior surface includes an inner track;
wherein the at least one first sealing part is mounted in the inner track and designed to seal towards the insert, and
wherein the at least one second sealing part is mounted in the outer track and designed to seal against the hollow part including the pipe.

19. The coupling according to claim 18, wherein the outgrowth includes an outer surface in which the outer track is fully or partially placed and the at least one second sealing part is mounted in the outer track and designed to seal against the hollow part including the pipe, and wherein one end surface of the coupling includes the inner track in which the at least one first sealing part is mounted and designed to sealing towards the insert.

20. The coupling according to one or more of claim 18, wherein the base part is configured to create a mechanical locking between the coupling and the hollow part, wherein the mechanical locking includes a mesh with an embossing in the pipe, an embossing in the coupling congruent with the embossing in the pipe and a free surface projecting from the outgrowth whose surface consists of a part of the outer track.

21. The coupling according to claim 18, wherein the base part consists of an electrically conducting material, preferably an electrical conducting polymer, and wherein the coupling is configured to have physical contact to both the insert and the hollow part including the pipe.

22. The coupling according to claim 18, wherein the contact between the coupling and the insert includes a contact zone having a lip contact, and wherein the contact between the coupling and the hollow part includes another contact zone having a pressure contact.

23. The coupling according to claim 22, wherein the lip contact is established by the one end of the coupling and opposite the end where the outgrowth is placed.

24. The coupling according to claim 22, wherein the pressure contact includes an embossing in the hollow part, wherein the embossing is designed to mesh with a mostly identical embossing on the outer surface of the base part.

25. The coupling according to claim 18, wherein the first sealing part and the second sealing part consist of an elastic material such as a polymer for example an elastomer, which creates a sealing between the base part to the insert and the hollow part including the pipe.

26. The coupling according to claim 25, wherein the elastic material has a hardness of 45-70 shoreA preferably 50-65 shoreA.

27. The coupling according to claim 18, wherein the first sealing part and the second sealing part are placed at the same end on the base part.

28. The coupling according to claim 18, wherein the coupling is manufactured by injection molding including a two-component injection molding.

29. The coupling according to claim 18, wherein the base part and the first and second sealing parts are connected to each other by a chemical and/or thermal fusion.

30. The coupling according to claim 18, wherein the coupling is designed to be placed in round or polygonal holes and around round or polygonal inserts.

31. The coupling according to claim 18, wherein the coupling is manufactured from one or more materials including metallic, polymeric, mineral and/or biological materials.

32. Use of the coupling according to claim 18, wherein there is to be guided and/or sealed in a hole, including a pipe and an insert such as a pipe or an axle where the insert is designed to be moved in relation to the coupling whereby filth on the insert is exposed and makes it possible to scrap it off and/or there is established a conducting connection between the insert and the hollow part including a pipe where this connection counteracts static electricity.

33. The use of coupling according to claim 32 for connections where the connection must comply with 3A and EHEDG requirements for cleaning-friendliness.
